(19) United States
(12) Patent Application Publication
(10) Pub. No.: US 2015/0302438 A1
(43) Pub. Date: Oct. 22, 2015

(54) Systems and Methods for Generating Competitive Merchant Sets for Target Merchants

(71) Applicant: MASTERCARD INTERNATIONAL INCORPORATED, Purchase, NY (US)

(72) Inventor: Rohit Chauhan, Somers, NY (US)

(73) Assignee: MASTERCARD INTERNATIONAL INCORPORATED, Purchase, NY (US)

(21) Appl. No.: 14/256,545

(22) Filed: Apr. 18, 2014

(51) Int. Cl. G06Q 30/02; G06Q 10/06

(52) U.S. Cl. CPC G06Q 30/0205; G06Q 10/0637

(57) ABSTRACT

Exemplary systems and methods for generating competitive merchant sets for target merchants are disclosed. One exemplary method includes compiling a sample of merchants from a database of merchants, determining a ticket size score, determining a proximity score for each merchant in the sample of merchants, and determining a historic relation score for each merchant in the sample of merchants. The exemplary method further includes generating a competitive merchant set, based on a combination of the ticket size score, proximity score, and the historic relation score.

### FIELD

The present disclosure relates to systems and methods for generating competitive merchant sets, for target merchants, based on one or more measures of competition with other merchants such as, for example, proximity, ticket size, and historic relation.

### BACKGROUND

This section provides background information related to the present disclosure which is not necessarily prior art.

Payment accounts are known to be used to purchase a variety of different goods and services from merchants. Payment accounts are generally associated with credit cards, debit cards, prepaid cards, and other payment forms, which are used to post transactions to payment accounts. Transactions to such payment accounts are subject to approval or rejection, by communication of the transactions through a payment network. Different entities involved in passing the transaction through the payment network often gather information related to the transaction. Separately, merchants are known to compete with other merchants to provide goods and services to consumers.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in compiling a competitive merchant set for a target merchant.

FIG. 2 is a block diagram of a computing device that may be used in the exemplary system of FIG. 1.

FIG. 3 is an exemplary method for generating a competitive merchant set for a target merchant.

FIG. 4 is an exemplary relationship tree for determining a historic relation score according to some aspects of the present disclosure.

Corresponding reference numerals indicate corresponding parts throughout the several views of the drawings.

### DETAILED DESCRIPTION

Example embodiments will now be described more fully with reference to the accompanying drawings.

The inventor hereof has recognized that merchants often assess whether certain merchants are competitors based on their perceptions of not only the other merchants, but perceptions about themselves. When a merchant's perceptions are errant, one or more certain merchants may be identified as a competitor to a merchant, when in fact, they are not. The systems and methods herein generate competitive merchant sets for a target merchant, based on objective measures of competition with other merchants, such as ticket size, proximity and historic relation. By use of objective measures, competitive merchant sets are generated, which are more precise than the merchant's perception, and thus, may be used to improve strategies in competing with such other merchants.

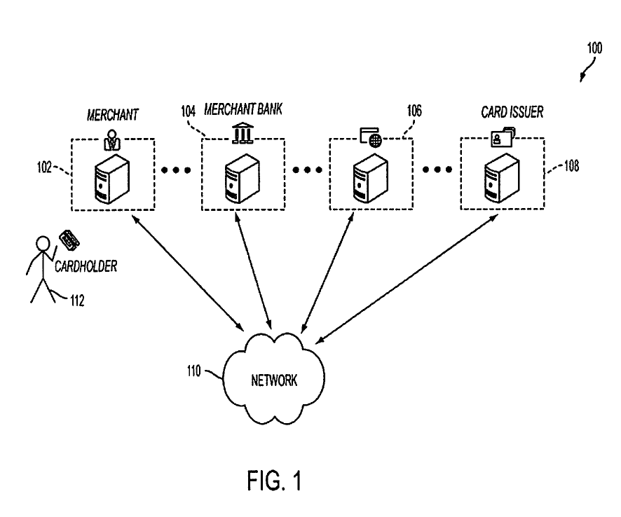

FIG. 1 illustrates an exemplary system 100, in which the one or more aspects of the present disclosure may be implemented. Although, in the described embodiment, components of the system 100 are presented in one arrangement, other embodiments may include the same or different components arranged otherwise, depending, for example, on authorization processes for payment card transaction systems.

Referring to FIG. 1, the system 100 generally includes a merchant 102, a merchant bank (or acquirer) 104, a payment service 106, and an issuer (and/or issuer bank) 108, each coupled to network 110. The network 110 may include, without limitation, a local area network (LAN), a wide area network (WAN) (e.g., the Internet, etc.), a mobile network, a virtual network, and/or another suitable public and/or private network capable of supporting communication among two or more of the components illustrated in FIG. 1, or any combinations thereof. For example, network 110 may include multiple different networks, such as a transaction network accessible by the payment service 106 and/or the Internet.

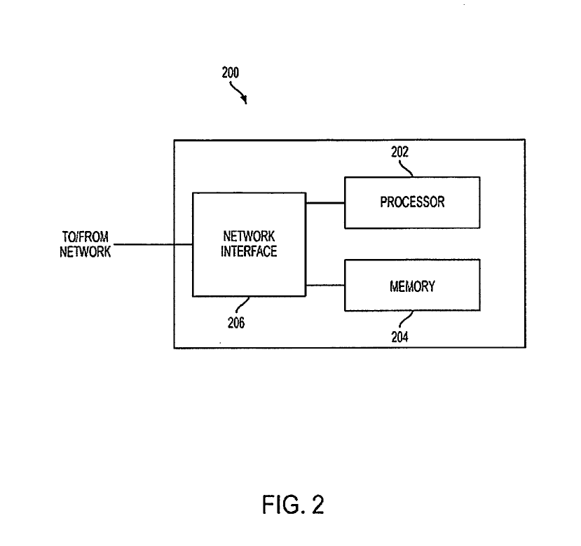

Each of the merchant 102, the merchant bank 104, the payment service 106, and the issuer 108 in the illustrated system 100 may be implemented in any one or more computing devices, such as a computing device or multiple computing devices located together, or distributed across a geographic region. For illustration, the system 100 is further described below with reference to an exemplary computing device 200 illustrated in FIG. 2. The system 100, and the components therein, however, should not be considered to be limited to the computing device 200, as different computing devices and/or arrangements of computing devices may be used in other embodiments.

As shown in FIG. 2, the exemplary computing device 200 includes a processor 202 and a memory 204 coupled to the processor 202. The processor 202 may include, without limitation, a central processing unit (CPU), a microprocessor, a microcontroller, a programmable gate array, an ASIC, a logic device, or the like. The memory 204 is a computer readable media, which includes, without limitation, random access memory (RAM), a solid state disk, a hard disk, compact disc read only memory (CD-ROM), erasable programmable read only memory (EPROM), tape, flash drive, and/or any other type of volatile or nonvolatile physical or tangible computer-readable media. Memory 204 may be configured to store, without limitation, transaction data, consumer information, merchant information, and/or other types of data suitable for use as described herein.

The computing device 200 further includes a network interface 206 coupled to the processor 202. The network interface 206 may include, without limitation, a wired network adapter, a wireless network adapter, a mobile telecommunications adapter, or other device capable of communicating to one or more different networks, including the network 110. In at least one embodiment, computing device 200 includes processor 202 and one or more network interfaces 206 incorporated into or with processor 202.

Referring again to FIG. 1, the merchant 102, the merchant bank 104, the payment service 106, and the issuer 108 cooperate, in response to a request from a consumer 112, to complete a payment transaction.

As an example, in a credit transaction in the system 100, the merchant 102 reads a payment device and communicates the account number and an amount of the purchase to the merchant bank 104 to determine whether the card is in good standing and whether there is sufficient credit to complete the transaction. The merchant bank 104, in turn, communicates with the issuer 108 through a payment service 106, such as, for example, a payment system using the MasterCard® interchange, for authorization to complete the transaction. If the issuer 108 accepts the transaction, an authorization is provided back to the merchant 102 and the merchant 102 completes the transaction. The transaction is posted to the payment account associated with the consumer 112. The transaction is later settled by and between the merchant 102, the merchant bank 104, and the issuer 108. In other exemplary transactions, a transaction may further include the use of a personal identification number (PIN) authorization, or other steps associated with identifying a payment account and/or authenticating the consumer 112, etc.

Transaction data is generated, collected, and stored as part of the above interactions among the merchant 102, the merchant bank 104, the payment service 106, the issuer 108, and the consumer 112. The transaction data includes the transactions to one or more payment accounts, which include without limitation, payment account numbers, ticket size, merchant identification (ID), merchant category code (MCC), and a date/time of the transaction, etc., which is present in the payment network to authorize transactions between multiple merchants 102 and multiple issuers 108. Transaction data may further include other product specific information, such as model numbers, brands, price per item or service, etc. It should be appreciated that still other transaction data related to transactions, products, consumers and/or merchants may further be collected and/or stored within the system 100.

Transaction data, from multiple transactions, involving multiple different consumers and merchants, is stored in different components of the system 100. In various embodiments, the payment service 106, for example, collects and stores the transaction data in memory 204. In particular, the payment service 106 stores transaction data for multiple payment accounts, each associated with one or more consumers 112. The transaction data may be stored in memory 204, according to the payment account, the merchant involved in the transactions, or any other criteria, such that the transaction data is readily usable as described herein. Additionally, or alternatively, in various embodiments, the acquirer 104, the issuer 108, or other components of the system 100, or other entities, may collect transaction data, and/or store it in the memory 204 associated therewith. In combination with or separate from the transactions data, the payment service 106 further includes, in memory 204, a database of merchants, which may or may not be involved in one or more transactions to one or more payment accounts identified by or known to the payment service 106. In various embodiments, the merchants 102 register to the database of merchants, or otherwise identify themselves to the payment service 106. In multiple embodiments, any of the merchants 102 in the merchant database may be a target merchant as described herein. The payment service 106 may generate a competitive merchant set, for the target merchant, as a service to the target merchant. In other embodiments, different entities, shown in FIG. 1, may be involved in generating one or more competitive merchant sets.

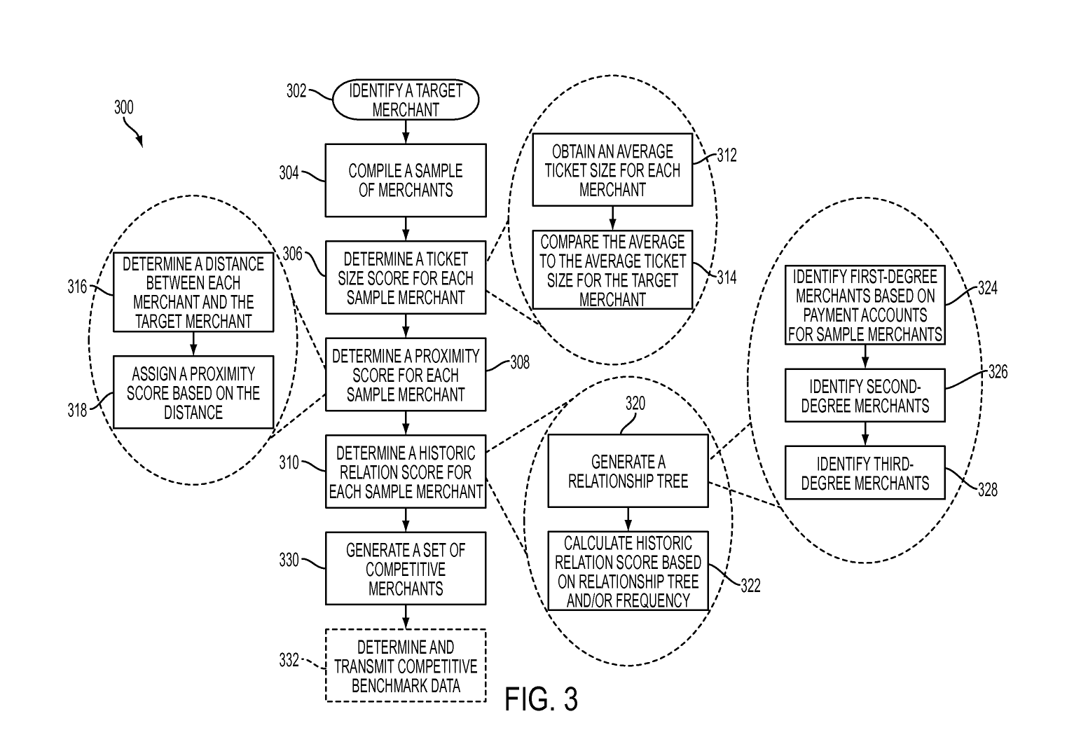

FIG. 3 illustrates an exemplary method 300 of generating a competitive merchant set for a target merchant. The exemplary method 300 may be implemented in any one or more of the acquirer 104, the payment service 106, and the issuer 108 of the system 100, each of which includes one or more computing devices, as described above. For purposes of illustration, the exemplary method 300 is described herein with reference to computing device 200. It should be appreciated that the methods described herein are not limited to the system 100, or computing device 200. And, conversely, the systems and computing devices described herein are not limited to the exemplary method 300.

As part of the exemplary method 300, the processor 202 identifies a target merchant at 302, for which the competitive merchant set is to be created, and then compiles a sample of merchants at 304 for the target merchant. The sample of merchants may be compiled, for example, from a database of merchants. Each merchant in the sample typically has some relation to a target merchant, such that each merchant may be considered as a possible competitor with the target merchant. The sample of merchants may be selected using any suitable selection criteria indicative of a potential competitive relation between the merchant and the target merchant, and including, for example, merchants located within a certain proximity of the target merchant (e.g., based on geographical distance, travel time over roads, same ZIP code, same city, etc.), merchants having at least some ticket size(s) within a certain range relative to the target merchant (e.g., based on an average of all ticket sizes within a fixed dollar amount, a median of a subset of the ticket sales within a fixed dollar amount, an average of all ticket sizes within a time interval within a fixed percentage range, etc.), merchants having a historic relation to the target merchant (e.g., having transactions included in the same pay accounts of one or more customers, having an amount of overlap in a relationship tree, etc.), etc. The sample of merchants may be compiled using any one of the above selection criteria, one or more other selection criteria, or may use a combination of selection criteria. For example, the sample of merchants may include all merchants having transactions included in the same payment accounts as the target merchant that also are within ten miles of the target merchant and have an average ticket price within thirty dollars of the target merchant. It is understood that in other embodiments, various selection criteria, ranges and/or values may be used to compile the sample.

Information about the merchants (e.g., location, average ticket price, etc.), and/or transaction data for multiple customers of the merchants may be stored in memory 204. The processor 202 may access the memory 204 to retrieve merchant locations, average ticket size, transaction history for customer pay accounts, etc., and may use this information to determine distances between merchants, differences between average ticket sizes, merchants included in the same pay accounts of customers based on transaction data, etc.

In some embodiments, the sample of merchants may only include merchants having the same (or similar) merchant category code(s) as the target merchant. For example, if the target merchant has a restaurant merchant category code, the compiled set of would-be merchants may only include merchants also having a restaurant or eating place merchant category code.

In the illustrated method 300, after compiling the sample of merchants, as shown in FIG. 3, the processor 202 determines a ticket size score for each merchant in the sample at 306, determines a proximity score for each merchant in the sample at 308, and determines a historic relation score for each merchant in the sample at 310. While each is illustrated in a particular order in FIG. 3, it should be appreciated that the scores may be determined in any order, or at the same time, in different embodiments. Further, one or more scores, as described, may not be determined in some embodiments.

The processor 202 determines a ticket size score for each merchant in the sample at 306 based on ticket size data for the merchant relative to ticket size data for the target merchant. As part of determining a ticket size score at 306, the processor 202 optionally (indicated by the dotted lines) obtains or calculates an average ticket size for the merchant at 312. The processor 202 then compares the average ticket size for the merchant with an average ticket price for the target merchant at 314. Thus, the ticket size score may be based on an average ticket size for the merchant relative to an average ticket size for the target merchant. The ticket size score may be based on any other suitable ticket size data, such as, for example, an average ticket size, a median ticket size, a mode ticket size, etc. Ticket size scores may be further based on all ticket size data, or may be based on only a portion of ticket size data for each merchant. For example, in some embodiments, the processor 202 determines a ticket size score based on ticket size data within a predetermined time interval (e.g., the last year, the last three months, only after 5:00 p.m., only on the weekends, etc.) or a subset of the ticket size data (e.g., ignoring the top percentages and bottom percentages, including only ticket sizes within a range, etc.). In various embodiments, the exemplary method 300 may use any suitable combination, or formula or mathematical operation indicative of general ticket size at each merchant.

In one example, the ticket size score at 306 may be indicative of a difference between an average ticket price of a merchant in the sample and an average ticket price of the target merchant. In this example, if the target merchant has an average ticket price of fifteen dollars, a merchant in the sample having an average ticket price of twenty dollars may have a smaller ticket size score than a merchant in the sample having an average ticket price of forty dollars. A smaller ticket size score, in some examples, may be indicative of a closer average ticket price between the target merchant and a merchant in the sample, and an increased likelihood the merchant is a competitor with the target merchant. In some embodiments, the processor 202 calculates an average ticket size for each merchant, while in other embodiments, the processor 202 does not calculate the ticket size, but retrieves an average ticket size score for each merchant previously stored in memory 204.

The processor 202 may determine a proximity score for each merchant in the sample at 308. As part of determining a proximity score, the processor 202 optionally determines a distance between each merchant and the target merchant at 316, and assigns a proximity score based on the distance therebetween at 318. The proximity score, in this example, is based on a distance (e.g., a straight line geographical distance between the merchants, an amount of time to travel between the merchants along roads, walking, using public transportation, etc.). In other embodiments, the proximity score is based on a merchant in the sample, located within a predetermined boundary with the target merchant (e.g., ZIP code, city, county etc.), etc. The processor 202 may retrieve locations for each merchant, stored in memory 204, and then determine a distance between the merchants and/or whether the merchants are located within the same boundary, etc. In one example, a merchant in the sample located 2.4 miles from the target merchant may have a smaller proximity score than a merchant in the sample located 8.0 miles from the target merchant. In this example, a smaller proximity score may be indicative of a closer distance between the merchant and the target merchant, and an increased likelihood the merchant is a competitor with the target merchant.

As shown in FIG. 3, the processor 202 determines a historic relation score for each merchant in the sample at 310. As a part of determining the historic relation score at 310, the processor 202 optionally generates a relationship tree from the sample of merchants at 320. The processor 202 then calculates the historic relation score based on an amount of overlap of a merchant in the sample in the relationship tree at 322. The historic relation score may be calculated, in some examples, merely by assigning a score based on the position of the merchant in the relationship tree, or in other examples, based on the overlap of the merchant in one or more payment accounts, or in still other embodiments, based on the position of the merchant in the relationship tree and the overlap of the merchant in one or more payment accounts.

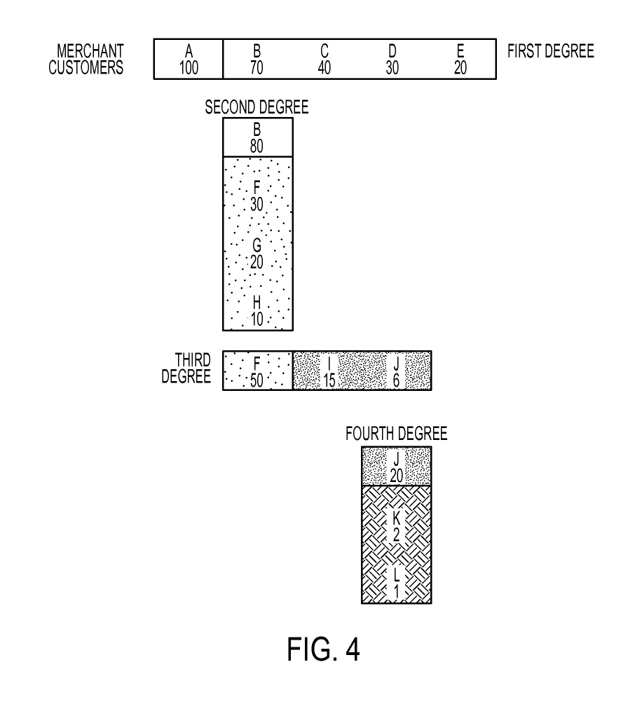

FIG. 4 illustrates an example relationship tree. Of 100 customers that have a payment account transaction involving Merchant A, 70 of them also have a payment account transaction involving Merchant B, 40 of them also have a payment account transaction involving Merchant C, etc. These merchants (i.e., Merchant B, Merchant C, Merchant D and Merchant E) are considered to have a direct overlap with the target merchant because they share customers that have a transaction to both the merchant and the target merchant in the same payment account. These directly overlapping merchants may also be considered as first-degree merchants because there is only one degree of connection therebetween.The amount of direct overlap may be determined by the amount of customers shared between a first-degree merchant and the target merchant. In this example, Merchant B has a greater amount of direct overlap than Merchant C because 70 of target Merchant A's customers also visited Merchant B, while only 40 of target Merchant A's customers also visited Merchant C.

Merchants that are connected to the target merchant through more than one degree of overlapping customer payment account transactions have an indirect overlap with the target merchant. For example, merchants connected to the target merchant through two degrees of overlapping customer payment accounts are considered second-degree merchants. In the example of FIG. 4, second-degree merchants can be determined by looking at customers that have a payment account transaction involving Merchant B (i.e., a first-degree, directly overlapping merchant), but not a payment account transaction involving the target Merchant A. Of the 80 customers that have a payment account transaction involving Merchant B, 30 also have a transaction at Merchant F, 20 also have a transaction at Merchant G, etc. Merchants F, G, and H are considered second-degree merchants. Although not shown in FIG. 4, a separate second-degree branch could also be created for the each of the other first-degree merchants (i.e., Merchant C, Merchant D, and Merchant E).

The amount of indirect overlap between a merchant and the target merchant may be determined by the amount of customers shared between a second-degree merchant and the target merchant. In this example, Merchant F has a greater amount of indirect overlap than Merchant G because 30 of first-degree Merchant B's customers also visited second-degree Merchant F, while only 20 of Merchant B's customers also visited second-degree Merchant G. Alternatively, or in addition, the amount of indirect overlap may be based on the amount of direct overlap of the first-degree merchant through which the second-degree merchant is connected to the target merchant. In this example, second-degree merchants connected to first-degree Merchant B may have a greater amount of overlap than any second-degree merchants connected to first-degree Merchant C (not shown) because Merchant B has a greater amount of direct overlap with the target Merchant A than Merchant C has with Merchant A.

This process can be continued to develop further indirect overlap relationships in the tree. In this example, Merchants I and J are third-degree merchants with an indirect overlap because they share customers with second-degree Merchant F. Further, Merchants K and L are fourth-degree merchants with an indirect overlap because each shares customers with third-degree Merchant J. The process of extending the relationship tree could be extended as far as desired, and the number of branches (e.g., levels, degrees, etc.) may be limited based on how many merchants are desired for the competitive set. Alternatively, or in addition, the length of the branches may be limited based on a threshold of the amount of overlap. For example, the threshold cutoff may be about 25%, such that any merchants having an amount of overlap of less than 25% will not be included. In the example of FIG. 4, a 25% cutoff would permit Merchant D (30 of target Merchant A's 100 customers overlap with Merchant D) to be included in the relationship tree, but Merchant E and any other merchants in the first branch having less than 25 overlapping customers would be excluded.

Referring back to the exemplary method illustrated in FIG. 3 the example tree is constructed in levels, with first-degree merchants being identified at 324. Again, the first-degree merchant is a sample merchant involved in a transaction in a payment account, in which the target merchant is also involved in a transaction. Generally, a first-degree merchant is a merchant that has appeared in the same payment accounts as the target merchant. For example, transaction data for a payment account (e.g., for the consumer 112) includes a transaction at the target merchant, ABC Pizza, and a transaction at another merchant, DEF Thai. DEF Thai, is thus a first-degree merchant relative to ABC Pizza in the relationship tree, because ABC Pizza (“the target merchant”) has customers that also patronize DEF Thai, using the same payment account.

The relationship tree, as explained above, may further include second degree merchants. The second-degree merchants are identified from the sample of merchants at 326. In this embodiment, the tree is constructed in order by level, a first level, then second level, then third level, etc. As such, second-degree merchants are not first-degree merchants. A merchant will not be tested to be a second-degree merchant, if it has already been identified as a first-degree merchant. Instead, in this embodiment, a second-degree merchant is a merchant in the sample, which is involved in a transaction in a payment account, which includes a transaction involving a first-degree merchant. In the example above, when a payment account includes a transaction involving DEF Thai (i.e., a first-degree merchant) and XYZ Chinese, XYZ Chinese is identified as a second-degree merchant (as long as no payment account includes ABC Pizza (the target merchant) and XYZ Chinese). In this embodiment, third-degree merchants are identified, in a similar manner, at 328. A third-degree merchant is not a first-degree merchant or a second-degree merchant, but is involved in a transaction to a payment account, to which a second-degree merchant is involved in a transaction.

This process may be repeated for each level of the tree, until the tree has expanded to a desired number of levels, as described above with reference to FIG. 4. It should be apparent that the relationship tree may be expanded to any suitable number of levels by expanding the tree to include additional degrees of merchants in the sample using the transaction data of customers of the merchants in the sample.

The historic relation score may be based on one or more of several factors. One factor may include which degree branch the merchant resides on. In the example of FIG. 4, Merchant B resides on the first-degree branch and thus has a stronger historic relation score than Merchant I which resides on the third-degree branch. The processor 202 may calculate a smaller historic relation score for Merchant B, than for Merchant I. Thus, in this example, a smaller historic relation score indicates more overlap between customers of the merchant and the target merchant, and an increased likelihood of competition between Merchant B and the target merchant. Another factor may be the customer overlap. For example, Merchant B has 70% overlap with target Merchant A, and thus a stronger historic relation score, than Merchant D which only has a 30% overlap. An amount of overlap may generally refer to an amount of direct overlap and/or an amount of indirect overlap, and may include any of the above listed historic relation score factors, or other additional factors indicating a relationship with the target merchant through customer payment accounts. The amount of overlap may be determined using any measure or factor, or by any formula (weighted or un-weighted) combining two or more of the above factors and/or amounts of direct and/or indirect overlap.

Yet another factor that may be used to determine a historic relation score includes an amount of offshoot for merchants having only an indirect overlap or at least a second-degree relationship with the target merchant. The amount of offshoot may be determined by looking at where the second-degree (or further degree) branch was formed. For example, a second-degree merchant on a branch stemming from Merchant B will have a stronger historic relation score than a second-degree merchant on a branch stemming from Merchant D because Merchant B has a stronger overlap with the target Merchant A than Merchant D does.

As shown in FIG. 3, upon determining the score at 306, 308 and 310, the processor 202 then generates a competitive set at 330 based on a combination of the ticket size score, proximity score, and historic relation score for each merchant in the sample. The competitive set may be compiled by selecting merchants having a combination of scores within a threshold range (e.g., the smallest combination of scores, highest combination of scores, all scores below a threshold value, the lowest percentage value of scores, etc.) For example, the competitive merchant set may be generated (from the sample of merchants) by selecting the five, ten, twelve, fifteen, etc. sample merchants, whose combined ticket size score, proximity score, and historic relation score are the lowest (or highest) among the sample of merchants. In this manner, the competitive merchant set includes, generally, the merchants in the sample most likely to compete with the target merchant based on objective indicators. It should be appreciated that the competitive set may be any number of merchants, from the merchant sample, depending on, for example, criteria on which the merchant sample is compiled, and the precision and/or accuracy with which the processor is generating the competitive set. In one example, a target merchant may wish to know the five most competitive merchants within 10 miles; while in another example, a target merchant may simply wish to know the 25 most competitive merchants. The methods and systems herein may be used in a variety of different ways to provide the target merchant with an accurate indication of competition, subject to any limitations from the target merchant, if any.

In one exemplary embodiment, the processor 202 determines a merchant score, for each merchant in the sample, whereby the merchant score is used to generate the competitive set at 330. Specifically, for example, the processor 202 may determine a merchant score for each merchant in the sample, which is based on the merchant's ticket size score, proximity score and historic relation score. The merchant score may be determined based on any suitable combination of the scores (e.g., summing the scores directly, multiplying the scores, using a formula with weighted coefficients for each score, etc.). For example, a merchant score for a merchant may be determined by summing together the merchant's ticket size score, proximity score and historic relation score.

The score for the ticket size, proximity and the historic relation may be further weighted, and/or generated to reflect different impact of the generated competitive set. For example, where the ticket size is determined to be more important than proximity or the historic relation of the merchant, the ticket size score may be adjusted to reflect the importance. In one example, a ticket size score for Merchant A is 1.5, while the proximity score for Merchant A is 1.0 and the historic relation score is 1.3. And, in this example, the ticket size score for Merchant B is 1.0, while the proximity score is 1.5 and the historic relation score is 1.3. If the merchant score was the un-weighted sum of the three scores, the merchant score for Merchant A is 3.8 (i.e., 1.5+1.0+1.3), and the merchant score for Merchant B is 3.8 (1.0+1.5+1.3). The relative merchant scores indicate Merchant A and Merchant B are equally competitive. But if the ticket size score was weighted to indicate emphasis, by a factor of 1.4 (where a lower score indicates a more competitive merchant), the merchant score for Merchant A is 4.4 (i.e., (1.5×1.4)+1.0+1.3), and the merchant score for Merchant B is 4.2 (i.e., (1.0×1.4)+1.5+1.3). Thus, Merchant B, who had a smaller ticket size score than Merchant A, now has a merchant score, which is lower than the merchant score of Merchant A. Thus, in this example, where ticket size is emphasized, over proximity and historic relation, Merchant B is more competitive to the target merchant than Merchant A. It should be appreciated that the merchant score may be based on various different combination of the scores, weighted or un-weighted. And, further, scores combined into the merchant score may be weighted prior to combination to the merchant score, such as in determining the ticket size score at 306, proximity score at 308, and historic relation score at 310, described above.

Although this exemplary embodiment describes first calculating a separate ticket size score, proximity score and historic relation score for each merchant in the sample and then combining them to determine a merchant score for the merchant, it is understood that in other embodiments the order of determining scores may be different. For example, a merchant score may be determined for each merchant in the sample based on ticket size data, proximity, and historic relation, without first determining separate scores for each factor and combining them. Alternatively, the merchants in the sample at 302 may be compiled using one factor for selection criteria (e.g., all merchants within ten miles of the target merchant) and the merchant score may be based on determining the remaining or all factors (e.g., ticket size score and historic relation score). In one example, historic relation is used to compile the sample of merchants, such that all merchants within three levels of the target merchant are included in the sample of merchants. Then, the merchant score is generated based on a ticket size score, a proximity score, and a historic relation score, where the historic relation score is based on the amount of overlap of the merchants appearing in the tree, and not just the presence in the tree. Various different permutations of ticket size, proximity, and historic relation may be used, to compile a merchant sample and/or generate a competitive merchant set from merchants in the sample.

Upon generating the competitive merchant set at 330, the processor 202 stores the competitive merchant set from 330 in memory 204. Alternatively, or in addition, the processor 202 may optionally determine and transmit competitor benchmark information to a target merchant at 332, using network interface 206. The processor 202 may determine competitor benchmark information by processing merchant information and/or transaction data stored in memory 204. The competitive benchmark information may include any information related to merchants in the generated competitive set from 330, such as, for example, an average ticket price of the competitive set merchants, an average ticket price per customer, spending per customer, reoccurrence of visits per customer (e.g., monthly, weekly, daily, etc.), spending by time of day, spending by day of the week, share of customer purchases for merchants in the same category, days between customer visits, number of repeat buyers over a period (e.g., 1 month, 2 or more months, etc.), percentage of new customers as a percentage of total customers, an average distance of the competitive set merchants, a volume of transactions of the competitive set merchants, etc.

The processor 202 may transmit the competitor benchmark information to a target merchant using network interface 206. In some embodiments, the names of the merchants included in the competitive set generated at 330 are not provided to the target merchant. However, anonymous average benchmark information may still benefit the target merchant by allowing the target merchant to compare its own performance with benchmarks of objectively determined competitors, for use in business planning and strategy. The competitor benchmark information may provide insights to manage and drive business strategies, including business, advertising, pricing, and/or sales decisions. For example, the target merchant may wish to compare its average ticket size to the average ticket sizes of competitors (considering consumer volume or throughput) to decide whether the target merchant should increase or decrease its prices.

It should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) compiling, from a database of payment transactions linked by payment accounts, a sample of merchants based on at least one of: a ticket size associated with each merchant, relative to a ticket size for a target merchant, a proximity between each merchant and the target merchant, and a historic relation between each merchant and the target merchant in one or more payment accounts in the database, (b) generating a merchant score, for each merchant in the sample, based on at least the other of: the ticket size associated with each merchant, relative to the ticket size for the target merchant, the proximity between each merchant and the target merchant, and the historic relation between each merchant and the target merchant in one or more payments accounts in the database, and (c) including each merchant, from the sample of merchants, in a competitive merchant set, when the merchant score for the merchant is within a threshold range.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method of generating a competitive merchant set for a target merchant, from a database of merchants, the database including transactions to multiple payments accounts, the method comprising:
compiling a sample of merchants from the database of merchants;
determining a ticket size score, for each merchant in the sample of merchants, the ticket size score based on ticket size data for the merchant relative to ticket size data for the target merchant;
determining a proximity score for each merchant in the sample of merchants;
determining, at a processor, a historic relation score for each merchant in the sample of merchants, the historic relation score based on the amount of overlap between the target merchant and the merchant within each of the payment accounts; and
generating, at the processor, a competitive merchant set, based on a combination of the ticket size score, the proximity score, and the historic relation score, for each merchant, being within a threshold range.

2. The method of claim 1, wherein compiling the sample of merchants includes compiling the sample of merchants based on a historic relation of each merchant in the sample to the target merchant.

3. The method of claim 1, wherein the ticket size score is based on an average or median ticket size for the merchant over a predetermined time interval, relative to an average or median ticket size for the target merchant over the predetermined time interval.

4. The method of claim 1, wherein determining the historic relation score includes:
generating a relationship tree from the sample of merchants, the tree including at least first-degree merchants and second-degree merchants;
wherein each first-degree merchant is involved in a transaction to a first of the payment accounts, in which the target merchant is involved in a different transaction;
wherein each second-degree merchant is not a first-degree merchant, but is involved in a transaction to a second of the payment accounts, in which a first-degree merchant is involved in a different transaction; and
calculating the historic relation score based on an amount of direct overlap of the merchant and an amount of indirect overlap of the merchant in the relationship tree.

5. The method of claim 4, wherein the tree includes third degree merchants, wherein each third-degree merchant is not a first-degree merchant or a second-degree merchant, but is involved in a transaction to a third of the payment accounts, in which a second-degree merchant is involved in a different transaction; and
wherein calculating the historic relation score is further based on an amount of further indirect overlap of the merchant as a third-degree merchant in the relationship tree.

6. The method of claim 1, further comprising determining and transmitting, to the target merchant, competitor benchmark data based on the compiled competitive merchant set.

7. The method of claim 1, wherein the competitive set includes at least five merchants.

8. The method of claim 1, wherein the sample of merchants includes only merchants in a same merchant category as the target merchant.

9. The method of claim 1, wherein compiling the sample of merchants includes selecting merchants located within a specified distance range of the target merchant.

10. The method of claim 1, wherein the combination is a merchant score, the merchant score being a sum of the ticket size score, the proximity score, and the historic relation score; and
wherein the competitive merchant set includes merchants whose merchant score is below an upper limit of the threshold range.

11. A system for generating a competitive merchant set for a target merchant, the system comprising:
a computing device having a memory configured to store transaction data for multiple payment accounts, each payment account associated with a consumer, and a processor coupled to the memory, the processor configured to:
identify a sample of merchants from the transaction data based on a target merchant;
for each merchant in the sample, determine a merchant score based on a proximity of the merchant to the target merchant, a ticket size associated with the merchant, and a historic relation between the merchant and the target merchant; and
generate a competitive merchant set including multiple of the merchants in the sample such that the merchant score for each merchant in the competitive merchant set is within a threshold range.

12. The system of claim 11, wherein the ticket size is the average ticket size in the transaction data for the merchant; and
wherein the historic relation is based on a tree structure of the transaction data, the tree structure including merchants in the sample at a first level, when a transaction involving the merchant and a transaction involving the target merchant are present in one of the payment accounts.

13. The system of claim 12, wherein the tree structure includes a merchant in the sample at a second level, when a transaction involving said merchant and a transaction involving one of the first level merchants are present in one of the payment accounts.

14. The system of claim 13, wherein the historic relation, for each merchant, is a historic relation score based on an amount of direct overlap of the merchant at the first level and an amount of indirect overlap of the merchant at the second level.

15. The system of claim 11, wherein the processor is further configured to store, in the memory, the competitive merchant set; and
wherein the processor is further configured to determine and transmit, to the target merchant, competitor benchmark data based on the stored competitive merchant set.

16. The system of claim 11, wherein the historic relation includes a historic relation score, for each merchant, based on an occurrence of a transaction involving the merchant in a payment account, when a different transaction in said payment account involves the target merchant and/or a different merchant from the sample of merchants; and
wherein the merchant score is determined based on the historic relation score.

17. A non-transitory computer readable media comprising instructions executable that, when executed by at least one processor, cause the at least one processor to:
compile, from a database of payment transactions linked by payment accounts, a sample of merchants based on at least one of: a ticket size associated with each merchant, relative to a ticket size for a target merchant, a proximity between each merchant and the target merchant, and a historic relation between each merchant and the target merchant in one or more payment accounts in the database;
generate a merchant score, for each merchant in the sample, based on at least the other of: the ticket size associated with each merchant, relative to the ticket size for the target merchant, the proximity between each merchant and the target merchant, and the historic relation between each merchant and the target merchant in one or more payments accounts in the database; and
include each merchant, from the sample of merchants, in a competitive merchant set, when the merchant score for the merchant is within a threshold range.

18. The non-transitory computer readable media of claim 17, wherein the instructions are executable that, when executed by the at least one processor, cause the at least one processor to:
generate a relationship tree based on the stored payment transactions in the database, the tree including first-degree merchants, which are present in the same payment accounts as the target merchant, and second-degree merchants, which are present in the same payment accounts as the first degree merchant, but not present in the same account with target merchant;
wherein the historic relation, for each merchant, is based on a position of the merchant in the relationship tree relative to the target merchant.

19. The non-transitory computer readable media of claim 17, wherein the instructions are executable that, when executed by the at least one processor, cause the at least one processor to:
determine competitor benchmark information using the stored competitive merchant set, and transmit the competitor benchmark information to the target merchant.

20. The non-transitory computer readable media of claim 17, wherein the ticket size is one of an average ticket size, a median ticket size, and a mode ticket size.
